(19) United States
(12) Patent Application Publication
(10) Pub. No.: US 2014/0197930 A1
(43) Pub. Date: Jul. 17, 2014

(54) Field Device for Automation Technology

(71) Applicants: Amend Zenuni, Lorrach (DE); Jurg Wyss, Ettingen (CH); Ulrich Kaiser, Basel (CH)

(72) Inventors: Amend Zenuni, Lorrach (DE); Jurg Wyss, Ettingen (CH); Ulrich Kaiser, Basel (CH)

(73) Assignee: Endress + Hauser GmbH + Co. KG, Maulburg (DE)

(21) Appl. No.: 14/239,606

(22) PCT Filed: Jul. 18, 2012
(86) PCT No.: PCT/EP2012/064047

§ 371 Date: Feb. 19, 2014

(30) Foreign Application Priority Data
Aug. 24, 2011 (DE) 10 2011 081 517.1

(51) Int. Cl. G05B 19/418

(52) U.S. Cl. CPC G05B 19/4183
USPC 340/10.34

(57) ABSTRACT

A field device for automation technology, which has a metal housing for accommodating a field device electronics. On the field device at least one opening is provided, which is closable via a lid composed at least partially of a non-metallic material, wherein an RFID chip and an RF antenna are arranged in the housing in such a manner that communication and energy exchange with an RFID reading device arranged outside of the field device can transpire, and wherein the reading device is so embodied that it provides sufficient energy to the RFID chip when the energy supply to the field device is interrupted, in order to read out via the RFID antenna the data stored on the RFID chip.

The invention relates to a field device for automation technology.

It is known to use RFID “Radio Frequency Identification” transponders—often also referred to as RFID tags or radio tags—e.g. in the field of logistics for the identification of products and assemblies of products.

RFID tags enable automatic identification and locating of objects and therewith significantly facilitate the registering and providing of information and data. An RFID system is composed of an RFID transponder, respectively an RFID tag, which is associated with the object and includes the more relevant information and data, and a reading device for read-out of the information and data. The coupling between RFID tag and reading device occurs via magnetic alternating fields of smaller range or high frequency radio waves of greater range produced by the reading device. Data transmission occurs via the alternating fields, respectively high-frequency radio waves, produced by the reading device. In many cases, the chip is also supplied with energy via the alternating fields or the high-frequency radio waves.

RFID transponders/RFID tags have an RFID chip and an antenna and differ depending on transmission frequency, manufacturer and purpose of use. The RFID chip is composed usually of an analog circuit for receiving and transmitting, as well as a digital circuit and a memory, which is usually writable multiple times. The digital circuit is often implemented by a microcontroller. In the case of a passive RFID, chip, the energy taken up during the communication event via the antenna serves for the energy supply of the microcontroller. In the case of active RFID tags, the energy supply of the microcontroller occurs via its own installed energy source, e.g. a single-use battery. In the case of semi-active RFID tags, the installed energy source serves only for the energy supply of the digital circuit, respectively the microcontroller.

RFID tags work, depending on type, in the longwave region at 125-134 kHz, shortwave at 13.56 MHz, UHF at 865-869 MHz, respectively 950 MHz, or SHF at 2.45 GHz and 5.8 GHz.

The activated microcontroller in the RFID tag decodes the commands sent from the reading device. The reading device codes and modulates the response into the radiated electromagnetic field by field weakening using contact free, short circuiting (load modulation) or in counter-phase reflection of the alternating field transmitted by the reading devices (modulated backscattering). Therewith, the RFID tag transmits, for example, its own unchangeable serial number, the information and data of the associated object, etc. The RFID tag thus itself produces no field; rather, it influences the electromagnetic transmission field coming from the reading device.

In the case of field devices of automation technology with metal housings, the metal housing material effects a shielding of the electromagnetic data- and/or energy transmission, whereby the transmission path is usually limited to a few centimeters and therewith to the vicinity of the field device. Use of RFID technology in the field of automation technology is limited to a few special cases. A general application, respectively retrofitting, of field devices with RFID technology is so far not possible.

An object of the invention is to provide a field device of automation technology with an RFID functionality.

The object is achieved by features including that the field device has a metal housing for accommodating a field device electronics, that on the field device at least one opening is provided, which is closable via a lid composed at least partially of a non-metallic material, that an RFID chip and an antenna are arranged in the housing in such a manner that data exchange and energy exchange with an RFID reading device arranged outside of the field device can transpire. In a preferred embodiment of the field device of the invention, the RFID reading device is so embodied that it provides sufficient energy to the RFID chip when the energy supply to the field device is interrupted, in order to read out via the RFID antenna the data stored on the RFID chip. Preferably moreover, the display is an E-paper display or an LCD display. The components needed for implementing the RFID technology are so selected that a range of at least 1 m is achieved for wireless data transmission and energy transmission.

The terminology “reading device” is to be broadly construed in connection with the invention. Thus, it is especially also provided that the reading device can also write data and information into the RFID chip, respectively into an associated memory. The reading device can, thus, also be embodied as a writing/reading device. In this case, it is provided that the RFID tag is equipped with a dual port memory, so that data exchange between field device and RFID tag, on the one hand, and RFID tag and reading device, respectively reading/writing device, on the other hand, can transpire.

Furthermore, the reading device also can be a smart phone having NEC (Near Field Communication) and a suitable app. This corresponds to an RFID tag using 13.56 MHz.

The solution of the invention enables utilizing RFID functionality also over longer distances in the case of a conventional field device having a metal housing. Furthermore, an option is to read, respectively to write, the data stored in the field device also in the energyless state of the field device. This is important in the case of field devices applied in automation technology, since, for example, the parameter set of the field device can then be transferred without problem to a replacement-field device, without incurring long and costly downtimes in the automation plant.

An advantageous further development of the field device of the invention provides that the RFID chip and the RFID antenna are arranged on the inside of the lid. The lid is manufactured at least partially of a non-conducting material.

Moreover, it is provided that the RFID chip and the RFID antenna are associated with a display unit, wherein a display of the display unit is externally visible via a transparent viewing window provided in the lid.

Especially, it is provided in this connection that the RFID chip and the RFID antenna are arranged on a display support of a non-conducting material. Especially, the RFID components are located on a surface of a circuit board facing the inside of the lid.

An advantageous embodiment of the field device of the invention provides that the field device electronics communicates with the RFID chip and the RFID antenna via a wire connection or via a radio connection. In this regard, it is especially provided that the RFID chip in the normal operational case is supplied with energy internally via the field device.

Especially advantageous is when the stored data includes name plate data of the field device, information concerning hardware- and/or software components of the field device, and data stored before interruption of energy supply to the field device, such as measurement data, diagnostic data, counter reading, etc. and/or configuration/parameter data.

Moreover, it is provided that selected data, such as the bus address or the starting parameters of the field device, are stored in the RFID chip and are effective in the case of activating the field device.

A preferred embodiment of the field device of the invention provides that the RFID components are manufactured in MID technology on the lid or on the display support of the display unit. MID stands for Molded Interconnect Device.

The invention will now be explained in greater detail based on the appended drawing, the figures of which show as follows:

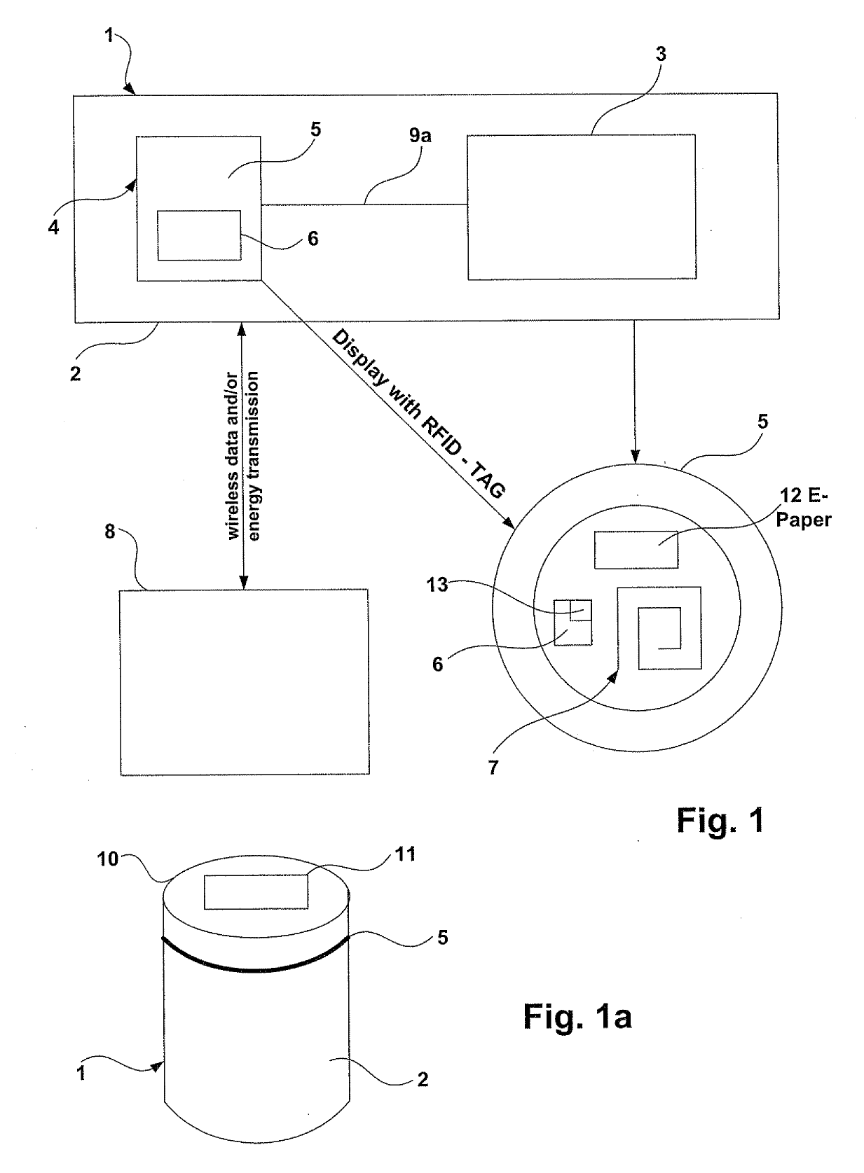

FIG. 1 a schematic representation of a first embodiment of the field device of the invention; and

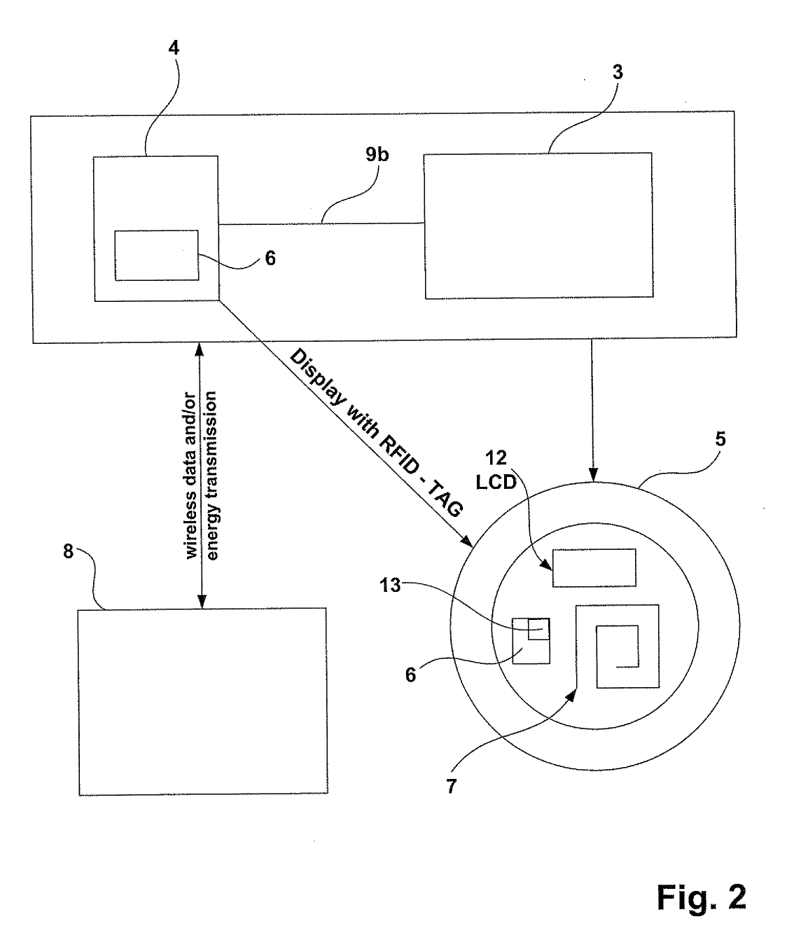

FIG. 2 a schematic representation of a second embodiment of the field device of the invention.

FIG. 1 shows a schematic representation of a first embodiment of the field device 1 of the invention especially suitable for use in automation technology. FIG. 2 shows a schematic representation of a second embodiment of the field device of the invention.

Field devices used in automation technology, especially in process and manufacturing, automation technology, serve for registering and/or influencing process variables. Serving for registering process variables are sensors, such as, for example, fill level measuring devices, flow measuring devices, pressure- and temperature measuring devices, pH-redox potential measuring devices, conductivity measuring devices, etc., which register the corresponding process variables, fill level, flow, pressure, temperature, pH-value, and conductivity, respectively. Serving for influencing process variables are actuators, such as, for example, valves or pumps, via which the flow of a liquid in a pipeline section, respectively the fill level in a container, can be changed. However, referred to as field devices are, in principle, all devices, which are applied near to the process and deliver, or process, process relevant information. Included in connection with the invention as field devices are thus also remote I/Os, radio adapters, and, in general, all devices, which are arranged at the field level. A large number of such field devices are produced and sold by the firm, Endress Hauser.

The field device 1 of the invention includes a metal housing 2, to which is secured a sensor element not separately illustrated in FIG. 1. Arranged in the housing 2 is the field device electronics 3. Field device 1 has an opening 4, which is closable via a lid 10 composed at least partially of a non-metallic material. Arranged in the housing 2 are, furthermore, an RFID chip 6 and an RF antenna 7. These are arranged in such a manner that communication and energy exchange with an. RFID reading device 8 outside of the field device 1 can transpire. The RFID reading device 8 is preferably a standard reading device. Reading device 8 is so embodied that it provides sufficient energy to the RFID chip 6, when the energy supply to the field device 1 is interrupted, in order that it can via the RFID antenna 7 read out the data stored on the RFID chip 6. The stored data includes, for example, name plate data of the field device 1, information concerning hardware- and/or software components of the field device 1, and data stored before interruption of the energy supply to the field device 1, such as measurement data, diagnostic data, counter reading, etc. and/or configuration/parameter data.

In a first embodiment, the RFID chip 6 and the RFID antenna 7 are arranged on the inside of the lid 10. This embodiment is not shown in the figures. Shown in the figures is the embodiment, in which the RFID chip 6 and the RFID antenna 7 are associated with a display support 5. In such case, the display 12 arranged on the display support 5 is externally visible via a transparent viewing window 11 provided in the lid 10. The display 12 can be any type of display, e.g. an LCD display (FIG. 1) or an electronic paper display (FIG. 2).

In the case of the example of embodiments shown in FIGS. 1 and 2, the RFID chip 6 and the RFID antenna 7 are associated with the display support 5. The display support 5 is preferably a circuit board. The RFID chip 6 and the RFID antenna 7 are arranged on the surface of the circuit board facing the inside of the lid 5.

Field device electronics 3 is connected with the RFID chip 6 and the RFID antenna 7 via a wire connection 9a (FIG. 1) or via a radio connection 9b (FIG. 2). In the normal operational case, the RFID chip 6 is supplied with energy via the wire connection 9a or the radio connection 9b.

Preferably, the RFID components 6, 7 on the lid 10 or on the display support 5 are manufactured in MID technology, wherein MID stands for Molded Interconnect Device.

Advantages of the solution of the invention include:
No cable connection with the field device 1 is necessary, in order in the normal operational case or in the energyless state to access the data stored in the data memory of the RFID chip.
In the case of an interruption of the energy supply, the field device 1 can still make stored data available.
For the purpose of identifying e.g. replacement parts, the field device 1 needs neither to be opened nor does it need to be isolated from the communication network, in which it is integrated. Rather, the corresponding data can be read-out without problem at any time.
A field device can be retrofitted with the RFID technology.
In the case of display via a display 12, the display content remains present, even in the currentless state.

An alternative solution is to separate a display unit from the actual field device. In such case, the display unit is embodied as a separate unit and has a metal housing. The earlier described embodiments for a field device 1 with integrated field device electronics 3 and with integrated display unit hold analogously for the separated display unit: The RFID components are integrated into the display unit in the already earlier described manner. They are either associated with the lid or with the display support. As a result of the separated display, a greater range can be achieved, which results from the range of the separated display unit and the range resulting from the use of the RFID technology.

### LIST OF REFERENCE CHARACTERS

1 field device

2 metal housing

3 field device electronics

4 opening

5 display support

6 RFID chip

7 RFID antenna

8 reading device

9a wire connection

9b radio connection

10 lid

11 viewing window

12 display

13 memory

1-9. (canceled)

10. A field device for automation technology, comprising:
field device electronics;
a list;
a metal housing for accommodating said field device electronics, wherein on said housing at least one opening is provided, which is closable via said lid composed at least partially of a non-metallic material;
an RFID chip; and
an RF antenna both arranged in said housing in such a manner that communication and energy exchange with an RFID reading device arranged outside of the field device can transpire, wherein:
said RFID reading device is so embodied that it provides sufficient energy to said RFID chip when the energy supply to the field device is interrupted, in order to read out via said RFID antenna the data stored on said RFID chip.

11. The field device system as claimed in claim 10, wherein:
said RFID chip and said RFID antenna are arranged on the inside of said lid.

12. The field device as claimed in claim 10, wherein:
said RFID chip and said RFID antenna are associated with a display support;
a display arranged on said display support is externally visible via a transparent viewing window provided in said lid.

13. The field device as claimed in claim 10, wherein:
said RFID chip and said RFID antenna are associated with said display support;
said display support is especially a circuit board; and
said RFID chip and said RFID antenna are arranged especially on the surface of said circuit board facing the inside of said lid.

14. The field device as claimed in claim 10, wherein:
said field device electronics communicates with said RFID chip and said RFID antenna via a wire connection or via a radio connection; and/or
said RFID chip is supplied with energy via said wire connection or said radio connection.

15. The field device as claimed in claim 10, wherein:
the stored data includes name plate data of the field device, information concerning hardware- and/or software components of the field device, and data stored before the interruption of the energy supply to the field device, such as measurement data, diagnostic data, counter reading, etc. and/or configuration/parameter data.

16. The field device as claimed in claim 10, wherein:
selected data, such as the bus address or the starting parameters of the field device, are stored in said RFID chip and are effective in the case of activating the field device.

17. The field device as claimed in claim 12, wherein:
said display is an E-paper display.

18. The field device as claimed in claim 10, wherein:
said RFID components on said lid or on said display support are manufactured in MID technology, wherein MID stands for Molded Interconnect Device.
